(19) United States
(12) Patent Application Publication
(10) Pub. No.: US 2022/0179597 A1
(43) Pub. Date: Jun. 9, 2022

(54) MODIFY AND OUTPUT PRINTOUT INCLUDING DATA IN PREDEFINED FORMAT

(71) Applicant: HEWLETT-PACKARD DEVELOPMENT COMPANY, L.P., Spring, TX (US)

(72) Inventors: Jihyun YOON, Pangyo (KR); Chulgee LEE, Pangyo (KR); Jihoon KIM, Pangyo (KR)

(73) Assignee: HEWLETT-PACKARD DEVELOPMENT COMPANY, L.P., Spring, TX (US)

(21) Appl. No.: 17/602,310

(22) PCT Filed: Oct. 16, 2020
(86) PCT No.: PCT/US2020/056004

§ 371 Date: Oct. 8, 2021

(30) Foreign Application Priority Data
Nov. 28, 2019 (KR) 10-2019-0155659

(51) Int. Cl. G06F 3/12; H04N 1/387

(52) U.S. Cl. CPC G06F 3/1208; G06F 3/1253; H04N 1/3871; G06F 3/1242; G06F 3/1273

(57) ABSTRACT

A method of operating an image forming apparatus includes obtaining first data in a defined format, the first data convertible to form an image; converting the first data into a first temporary image representing first information. A first image printable as a first printout is output, the first image resulting from combining the first temporary image with the first data.

### BACKGROUND

When an image forming apparatus receives a request for printing of a certain document or file, the image forming apparatus converts digital data of the certain document or file into an image including certain information and outputs the image as a printout.

When there is any modification needed in the printout, a user may modify information in the certain document or file and request the image forming apparatus to print a modified document or file.

### BRIEF DESCRIPTION OF DRAWINGS

FIG. 1 is a conceptual diagram for describing an operation of an image forming apparatus outputting a first printout including first data in a predefined format, which is used to form a certain image, and an operation of the image forming apparatus outputting a second printout reflecting modification based on the first printout, according to an example of the present disclosure.

FIG. 2 is a flowchart of a method of operating an image forming apparatus to output a printout including data used to form a certain image, according to an example of the present disclosure.

FIG. 3 is a flowchart of a method of operating an image forming apparatus to output a second printout, which results from modification of a first printout, based on the first printout, according to an example of the present disclosure.

FIG. 4 is a flowchart of a method of operating an image forming apparatus to obtain a second temporary image, which results from modification of a first temporary image, based on a first input for modifying a certain region of the first temporary image, according to an example of the present disclosure.

FIG. 5 is a diagram for describing a process of outputting an image, which results from combining a certain document with data in a predefined format corresponding to the certain document, when there is a request for printing of the certain document, according to an example of the present disclosure.

FIG. 6 is a diagram for describing a process of obtaining a second temporary image based on first modified data obtained from a first input when the first input for modifying a certain region of a first temporary image is received, according to an example of the present disclosure.

FIG. 7 is a diagram for describing a process of outputting a second printout, which results from modification of a first printout, based on the first printout, according to an example of the present disclosure.

FIG. 8 is a diagram for describing a modification option screen displayed on an image forming apparatus, according to an example of the present disclosure.

FIG. 9 is a diagram for describing a modification option screen displayed on an image forming apparatus, according to another example of the present disclosure.

FIG. 10 is a diagram for describing a process of outputting a second printout with harmful information deleted when a first printout including the harmful information is output, according to an example of the present disclosure.

FIG. 11 is a block diagram illustrating the configuration of an image forming apparatus, according to an example of the present disclosure.

### DETAILED DESCRIPTION

The term “image forming apparatus” may refer any type of apparatus, such as a printer, a scanner, a fax machine, a multi-function printer (MFP), or a display, which can perform an image forming operation. An “operation performed by an image forming apparatus” may involve printing, copying, scanning, faxing, saving, transmission, or the like.

Examples of the present disclosure will be described in detail hereinafter with reference to the accompanying drawings so as to be easily implemented by one of ordinary skill in the art to which the present disclosure belongs. The present disclosure may, however, be embodied in many different forms and is not limited to the examples set forth herein.

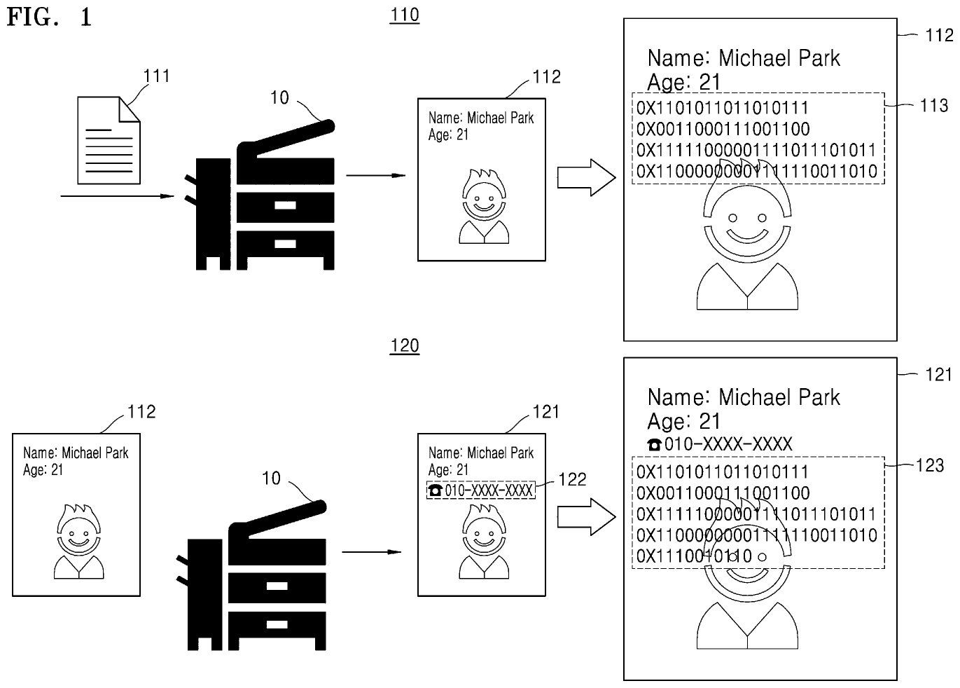

FIG. 1 is a conceptual diagram for describing an operation of an image forming apparatus outputting a first printout including first data in a predefined format, which is convertible to form a certain image, and an operation of the image forming apparatus outputting a second printout reflecting a modification based on the first printout, according to an example of the present disclosure.

Referring to 110 in FIG. 1, an image forming apparatus 10 may receive a print request for a certain document 111 from an electronic device. The image forming apparatus 10 may obtain first data 113 corresponding to the certain document 111.

The image forming apparatus 10 may receive the first data 113 from the electronic device or extract the first data 113 from a scanned image of the certain document 111. At this time, the first data 113 may have a predefined format and may be used to form a certain image. The first data 113 may be machine language that can be read by a processor of the image forming apparatus 10.

The image forming apparatus 10 may generate a temporary image for the certain document 111 and generate a first image by combining the temporary image with the first data 113. The image forming apparatus 10 may output a first printout 112 of the first image. The first data 113 may be superposedly displayed on the first printout 112. For example, the first data 113 may be transparently displayed.

Referring to 120 in FIG. 1, the image forming apparatus 10 may output a second printout 121 further including certain content in addition to the first printout 112.

For example, the image forming apparatus 10 may obtain the first image by scanning the first printout 112. The image forming apparatus 10 may extract the first data 113 from the first image and obtain the first temporary image with the first data 113 removed.

The image forming apparatus 10 may obtain a second temporary image by adding modification data such as a telephone number information 122 to the first temporary image based on an input for adding the telephone number information 122 to the first temporary image. The image forming apparatus 10 may generate the second image by combining the second temporary image with second data 123 representing second information obtained by combining the extracted first data 113 and the modification data to reflect a modification that may include a history of modifications, e.g., history of addition of the telephone number information 122. The image forming apparatus 10 may output the second printout 121 of the second image. The second data 123 may be superposedly displayed on the second printout 121.

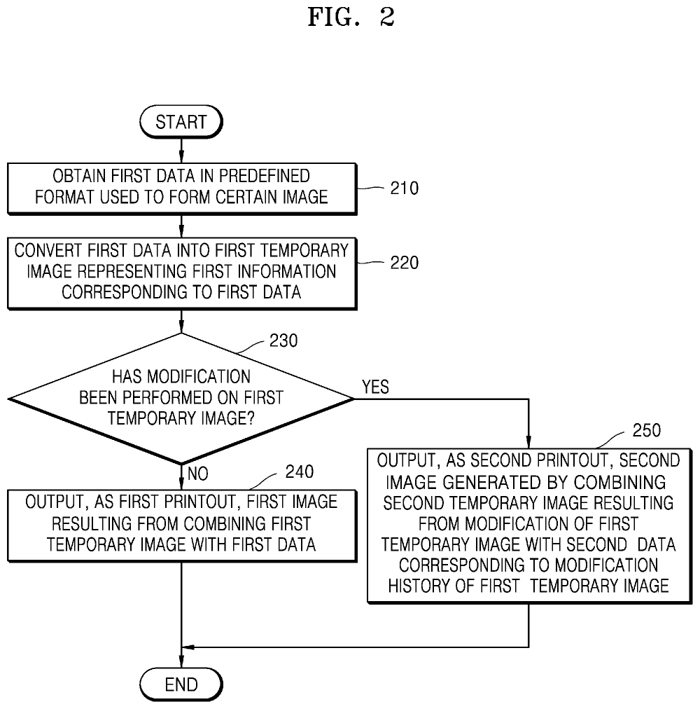

FIG. 2 is a flowchart of a method of operating an image forming apparatus to output a printout including data used to form a certain image, according to an example of the present disclosure.

Referring to FIG. 2, the image forming apparatus 10 may obtain first data in a predefined format, which is used to form a certain image, in operation 210.

For example, the first data may be composed of digital code. For example, the first data may be machine language that can be read by a processor of the image forming apparatus 10. The first data may be used for conversion into a certain image including at least one piece of text or at least one picture.

For example, the image forming apparatus 10 may receive a print request for a certain file from an external device or a copy request for a certain document through a user interface device of the image forming apparatus 10. In this case, the image forming apparatus 10 may obtain first data in a predefined format, which is used by being convertible to form a certain image, from the certain file or document.

The image forming apparatus 10 may convert the first data into the certain image as a first temporary image representing first information corresponding to the first data in operation 220.

For example, the image forming apparatus 10 may read the first data and obtain the first information corresponding to the first data. The first information may be represented by at least one piece of text or at least one picture. The image forming apparatus 10 may generate the first temporary image including the first information. For example, when the first data is original data of the certain document, file, or image, the first temporary image may be an original image.

The image forming apparatus 10 may check whether a modification has been performed on the first temporary image in operation 230. At this time, the modification may include a modification of the entire area of the first temporary image or a modification of a partial area of the first temporary image.

When the modification has not been performed on the first temporary image, the image forming apparatus 10 may output, as a first printout, a first image resulting from combining the first temporary image with the first data in operation 240. For example, the image forming apparatus 10 may obtain the first image having the first data superposed on the first temporary image and output the first image as the first printout.

For example, the first data may be transparently displayed on the first printout. The first data may be displayed in a certain size in a certain area of the first printout. The first data may be displayed in a margin of the first printout. The first data displayed on the first printout may be hard to be visually identified by a user.

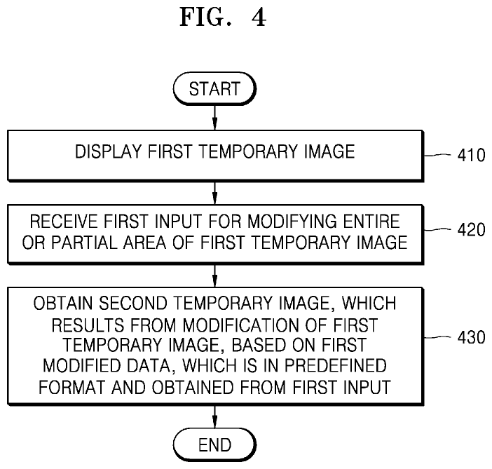

When the modification has been performed on the first temporary image, the image forming apparatus 10 may output a second image, which results from combining a second temporary image resulting from modification of the first temporary image with second data corresponding to a history of the modification of the first temporary image, as a second printout in operation 250. A process of obtaining the second temporary image resulting from the modification of the first temporary image will be described with reference to FIG. 4.

For example, the history of modification of the first temporary image may include at least one of a history of modification from the first temporary image to the second temporary image and a history of modification from the original image of the first temporary image to the first temporary image.

In the same manner as the first data is displayed on the first printout, the second data may be transparently displayed on the second printout. The second data may be displayed in a certain size in a certain area of the second printout. The second data may be displayed in a margin of the second printout. Because the second data is included in the second printout, the image forming apparatus 10 may obtain the second data, which includes original data and a modification history, from the second printout and may modify the second printout based on the second data or output a corresponding printout at a certain time.

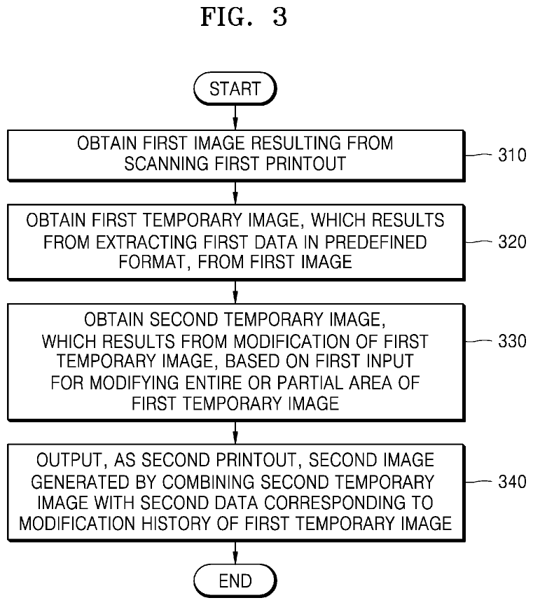

FIG. 3 is a flowchart of a method of operating an image forming apparatus to output a second printout, which results from modification of a first printout, based on the first printout, according to an example of the present disclosure.

The image forming apparatus 10 may obtain a first image, which results from scanning the first printout, in operation 310. For example, a scanner of the image forming apparatus 10 may scan the first printout and obtain the first image as the scan result.

The image forming apparatus 10 may obtain a first temporary image, which results from extracting first data in a predefined format from the first image, in operation 320. For example, the image forming apparatus 10 may extract the first data in a predefined format from the first image. The image forming apparatus 10 may read the first data and convert the first data into the first temporary image including first information.

The image forming apparatus 10 may obtain a second temporary image, which results from modification of the first temporary image, based on a first input for modifying an entire or a partial area of the first temporary image in operation 330. A process of obtaining the second temporary image resulting from the modification of the first temporary image will be described with reference to FIG. 4.

The image forming apparatus 10 may output a second image printable as a second printout, which is generated by combining the second temporary image with second data corresponding to a modification history of the first temporary image, in operation 340.

FIG. 4 is a flowchart of a method of operating an image forming apparatus to obtain a second temporary image, which results from modification of a first temporary image, based on a first input for modifying a certain region of the first temporary image, according to an example of the present disclosure.

The image forming apparatus 10 may display the first temporary image through a user interface device of the image forming apparatus 10 in operation 410. At this time, the first temporary image may be generated from first data.

The image forming apparatus 10 may receive the first input for modifying an entire or a partial area of the first temporary image in operation 420.

For example, the first input may be for modifying at least one selected from words in text and the size and color of the text in a certain area of the first temporary image.

For example, the first input may be for modifying the size or color of a picture in a certain area of the first temporary image or for entirely or partially changing the picture.

For example, the first input may request to delete a portion of the first temporary image other than a predefined format in a certain area.

For example, the first input may request to recover the first temporary image or a certain temporary image corresponding to a state before generation of the first temporary image. For example, the first input may request to recover an original image.

The image forming apparatus 10 may obtain the second temporary image, which results from modification of the first temporary image, based on first modified data in a predefined format in operation 430, wherein the first modified data is obtained from the first input.

For example, the image forming apparatus 10 may obtain the first modified data in the predefined format from the first input. When the first input is for modifying a letter in a certain area, the image forming apparatus 10 may obtain a modified letter as the first modified data in the predefined format. In detail, the image forming apparatus 10 may obtain digital code, by which the modified letter is expressed in machine language readable by a processor, as the first modified data.

For example, the image forming apparatus 10 may obtain second data by combining the first data with the first modified data. The second data may reflect a modification corresponding to the first input. For example, the image forming apparatus 10 may combine the first data with the first modified data based on a position corresponding to the first modified data in the first data and the place of the first modified data in a modification order.

The image forming apparatus 10 may convert the second data into the second temporary image, which results from modification of the entire or partial area of the first temporary image.

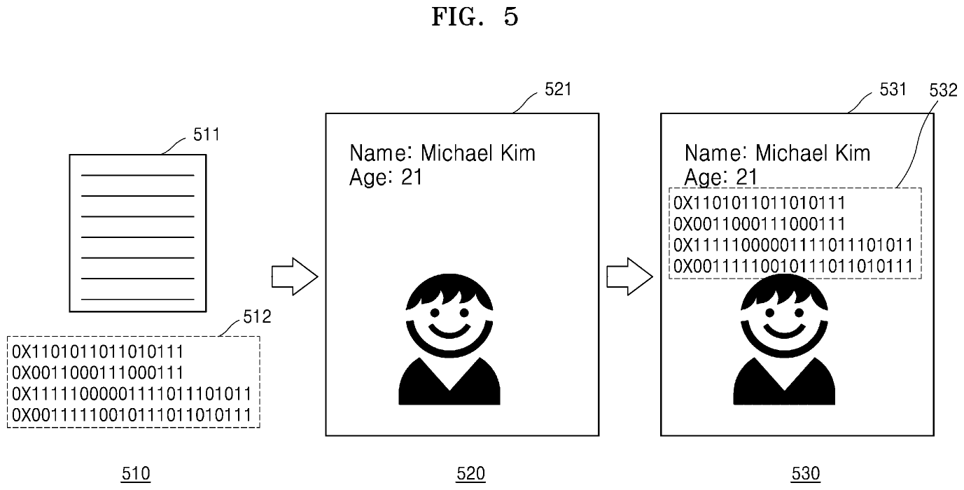

FIG. 5 is a diagram for describing a process of outputting an image, which results from combining a certain document with data in a predefined format corresponding to the certain document, when there is a request for printing of the certain document, according to an example of the present disclosure.

Referring to 510 in FIG. 5, the image forming apparatus 10 may receive a request for printing of a certain document 511. For example, the image forming apparatus 10 may receive a request for printing of the certain document 511 from a user's electronic device. When the image forming apparatus 10 outputs the certain document 511 as a first printout, the image forming apparatus 10 may generate a temporary image of the certain document 511 and output the first printout based on the temporary image. In this case, first data 512, which is used to generate the temporary image of the certain document 511, may have a predefined format. For example, the first data 512 may be composed of digital code. For example, the image forming apparatus 10 may receive the first data 512 for the certain document 511 from the user's electronic device.

Referring to 520 in FIG. 5, the image forming apparatus 10 may convert the first data 512 into a first temporary image 521. The first temporary image 521 may include first information about “Michael Kim”. In detail, the first information may include information about a name, age, and/or a picture.

Referring to 530 in FIG. 5, the image forming apparatus 10 may generate a first image 531 by combining the first temporary image 521 and the first data 512. For example, the image forming apparatus 10 may generate an image 532 representing the first data 512 and generate the first image 531 by combining the image 532 and the first temporary image 521.

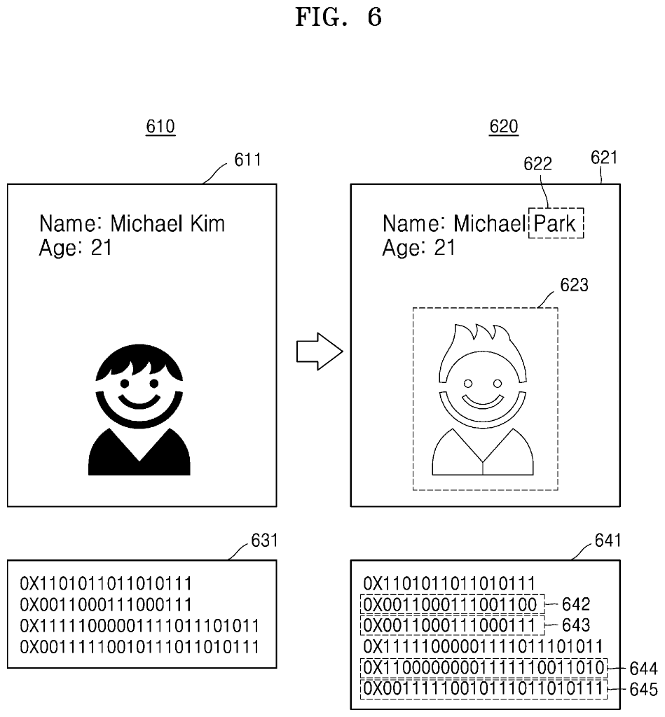

FIG. 6 is a diagram for describing a process of obtaining a second temporary image based on first modified data obtained from a first input when the first input for modifying a certain region of a first temporary image is received, according to an example of the present disclosure.

Referring to 610 in FIG. 6, the image forming apparatus 10 may display a first temporary image 611 on a user interface device. At this time, the first temporary image 611 may be generated by reading and converting first data 631 into text or a picture.

For example, when the image forming apparatus 10 receives a request for printing a certain file from an external device, the image forming apparatus 10 may obtain the first data 631. In another example, the image forming apparatus 10 may obtain a first image by scanning a first printout including the first data 631 and extract the first data 631 from the first image. The image forming apparatus 10 may convert the first data 631 into the first temporary image 611 and display the first temporary image 611 on the user interface device.

Referring to 620 in FIG. 6, the image forming apparatus 10 may receive a first input for modifying an entire or a partial area of the first temporary image 611. At this time, modification may include a modification of the content of the first temporary image 611 and/or a modification of the form of the first temporary image 611. The modification of the content may include a change of all or part of existing text or an existing picture. The modification of the form may include a change of all or part of the form without a change in the content. For example, the modification of the form may include a modification of at least one selected from font, size, thickness, and color of text displayed in the first temporary image 611.

For example, the image forming apparatus 10 may receive at least one of an input for modifying at least one selected from words, size, and color of text in a certain area of the first temporary image 611, an input for modifying size or color of a picture in the certain area, and an input for changing all or part of the picture.

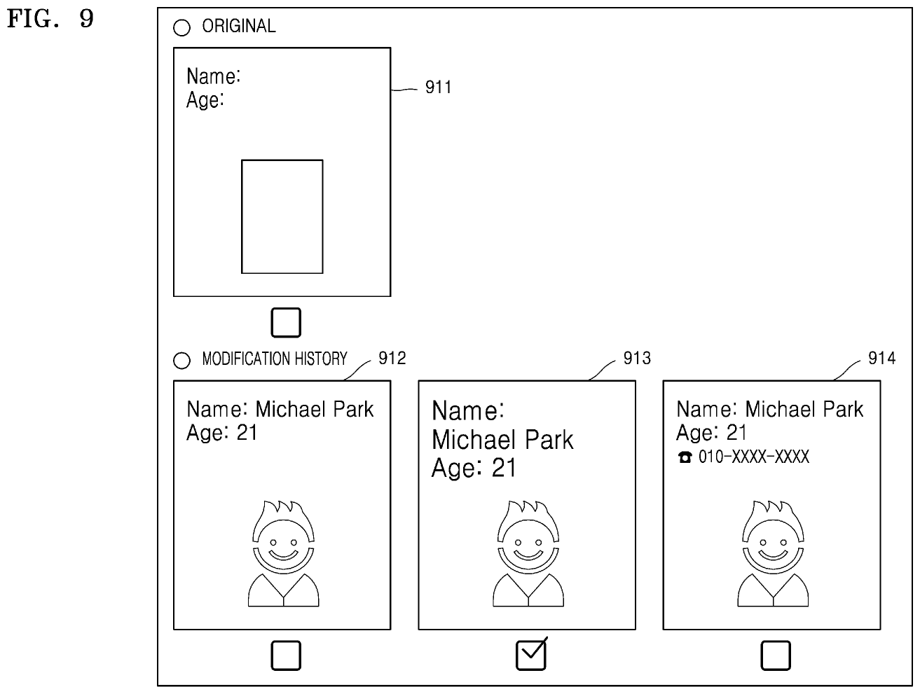

Although not shown in the image 620 in FIG. 6, the image forming apparatus 10 may receive an input requesting to delete a portion of the first temporary image 611 other than a predefined format in a certain area or an input requesting to recover a certain temporary image corresponding to a state before generation of the first temporary image 611. Operations related to the above example will be described with reference to FIG. 9.

Referring to the image 620 in FIG. 6, the image forming apparatus 10 may receive a first input for changing “Kim” to “Park” in the first temporary image 611 and a second input for changing a picture of Michael Kim to a picture of Michael Park. Here, the picture of Michael Park may have been stored in the image forming apparatus 10 as an image file in advance. The image forming apparatus 10 may obtain first modified data 642 in a predefined format according to the first input. The image forming apparatus 10 may also obtain second modified data 644 in a predefined format according to the second input.

For example, the image forming apparatus 10 may combine the first data 631 with the first modified data 642 based on a position corresponding to the first modified data 642 in the first data 631 and the place of the first modified data 642 in a modification order. The image forming apparatus 10 may also combine the first data 631 with the second modified data 644 based on a position corresponding to the second modified data 644 in the first data 631 and the place of the second modified data 644 in the modification order.

For example, when modifications are performed at the same positions in a certain temporary image, the image forming apparatus 10 may locate modified data corresponding to the latest modification before modified data corresponding to a modification performed prior to the latest one. Specifically, the image forming apparatus 10 may locate the first modified data 642 corresponding to “Park” before data 643 corresponding to “Kim”. The image forming apparatus 10 may also locate the data 644 corresponding to the picture of Michael Park before data 645 corresponding to the picture of Michael Kim. As shown in the image 620 in FIG. 6, the image forming apparatus 10 may obtain second data 641 by combining the first data 631 with the first modified data 642 and the second modified data 644.

The image forming apparatus 10 may convert the second data 641 into a second temporary image 621. In the second temporary image 621, text indicating “Kim” in the first temporary image 611 is changed to text 622 indicating “Park” and the picture of Michael Kim in the first temporary image 611 is changed to a picture 623 of Michael Park.

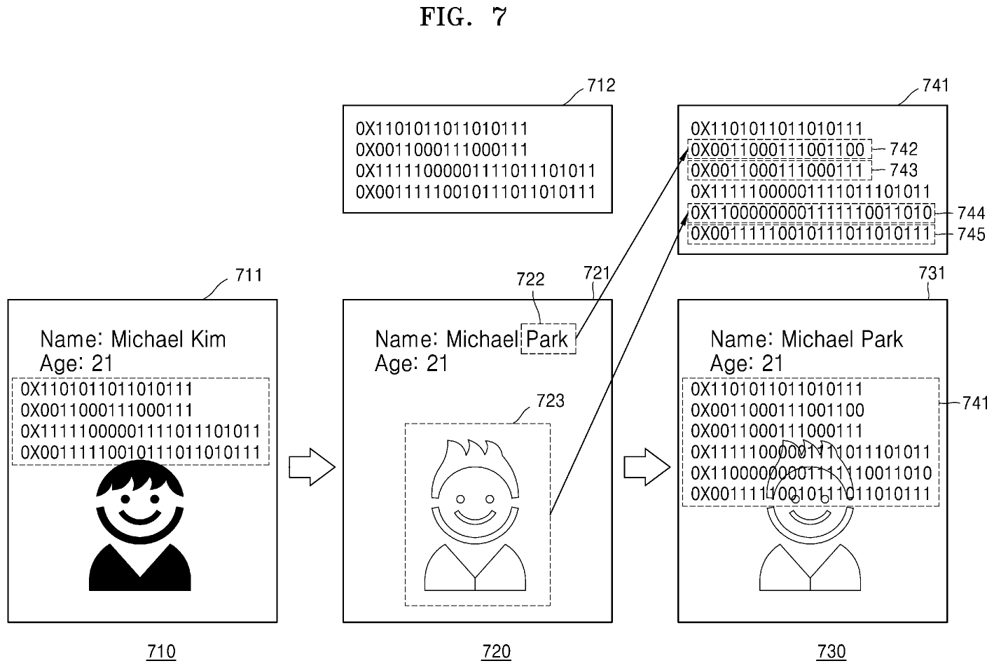

FIG. 7 is a diagram for describing a process of outputting a second printout, which results from modification of a first printout, based on the first printout, according to an example of the present disclosure.

Referring to 710 in FIG. 7, the image forming apparatus 10 may obtain a first image 711 by scanning the first printout. The first image 711 may include first data 712 in a predefined format. When the first data 712 in the predefined format is converted into information indicated by the first data 712, text and a picture of the first image 711 may be generated. The image forming apparatus 10 may obtain the first data 712 and a first temporary image 721, which results from exclusion of the first data 712 from the first image 711, by extracting the first data 712 from the first image 711. The image forming apparatus 10 may display the first temporary image 721 through a user interface device thereof.

Referring to 720 in FIG. 7, the image forming apparatus 10 may receive a first input 722 for changing “Kim” to “Park” in the first temporary image 721 and a second input 723 for changing a picture of Michael Kim to a picture of Michael Park.

Referring to 730 in FIG. 7, the image forming apparatus 10 may obtain first modified data 742 according to the first input 722 and second modified data 744 according to the second input 723. The image forming apparatus 10 may combine the first data 712 with the first modified data 742 and the second modified data 744 based on the positions and order of the modifications in the first temporary image 721. For example, the image forming apparatus 10 may obtain second data 741 by locating the first modified data 742 corresponding to “Park” before data 743 corresponding to “Kim” and locating the second modified data 744 corresponding to the picture of Michael Park before data 745 corresponding to the picture of Michael Kim.

The image forming apparatus 10 may generate a second image 731 by combining the second data 741 and a second temporary image corresponding to the second data 741 and may output the second image 731 as the second printout.

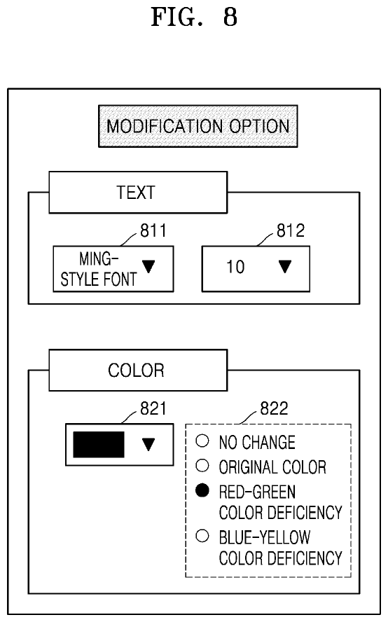

FIG. 8 is a diagram for describing a modification option screen displayed on an image forming apparatus, according to an example of the present disclosure.

The image forming apparatus 10 may receive an input for modifying an entire or a partial area of a temporary image. For example, the image forming apparatus 10 may receive an input for modifying at least one item related to text or a picture in the entire or partial area of the temporary image. For example, when not the content but the form of the entire or partial area of the temporary image is modified, the image forming apparatus 10 may display a modification option screen.

As shown in FIG. 8, the image forming apparatus 10 may display a menu allowing a font 811 and a size 812 of text to be changed. The image forming apparatus 10 may also display a menu allowing color of the entire or partial area of a temporary image to be changed. In detail, the image forming apparatus 10 may display a window 821 allowing color to be directly selected. The image forming apparatus 10 may also display a window 822 allowing no change, original color, color suitable for red-green color deficiency, or color suitable for blue-yellow color deficiency to be selected.

For example, the image forming apparatus 10 may receive an input for selecting “red-green color deficiency” in the window 822. Then, the image forming apparatus 10 may change the current color of an image to color allowing a user having red-green color deficiency to easily read a printout when outputting the printout of the image.

FIG. 9 is a diagram for describing a modification option screen displayed on an image forming apparatus, according to another example of the present disclosure.

The image forming apparatus 10 may output a printout corresponding to a previous image at a certain time point based on a modification history of a temporary image. In this case, the image forming apparatus 10 may display a modification option screen showing the modification history of the temporary image.

As shown in FIG. 9, the image forming apparatus 10 may display a thumbnail 911 of an original image and thumbnails 912, 913, and 914 of temporary images modified from the original image on the modification option screen. The image forming apparatus 10 may display the thumbnail 912 of a first temporary image, the thumbnail 913 of a second temporary image, and the thumbnail 914 of a third temporary image according to the modification history.

For example, the image forming apparatus 10 may receive an input for selecting the thumbnail 913 of the second temporary image from the thumbnails 911, 912, 913, and 914. The image forming apparatus 10 may output a second image, which results from combining the second temporary image corresponding to the thumbnail 913 that is selected with second data corresponding to the second temporary image, as a second printout.

In another example, as shown in FIG. 9, when the original image has a predefined format, a user may need the original image according to circumstances. The user may obtain an original printout corresponding to the original image from a third printout. Specifically, the image forming apparatus 10 may obtain a third image by scanning the third printout. The image forming apparatus 10 may extract third data in a predefined format from the third image and obtain the third temporary image resulting from extracting the third data from the third image. The image forming apparatus 10 may obtain the modification history of the third temporary image based on the third data. Here, the modification history of the third temporary image may include all history of modifications from the original image to the third temporary image.

The image forming apparatus 10 may display the thumbnail 911 of the original image and the thumbnails 912, 913, and 914 of the temporary images at different modifications on the modification option screen based on the modification history of the third temporary image. The image forming apparatus 10 may receive an input for selecting the thumbnail 911 of the original image. The image forming apparatus 10 may output an image, which results from combining the original image with original data, as a printout.

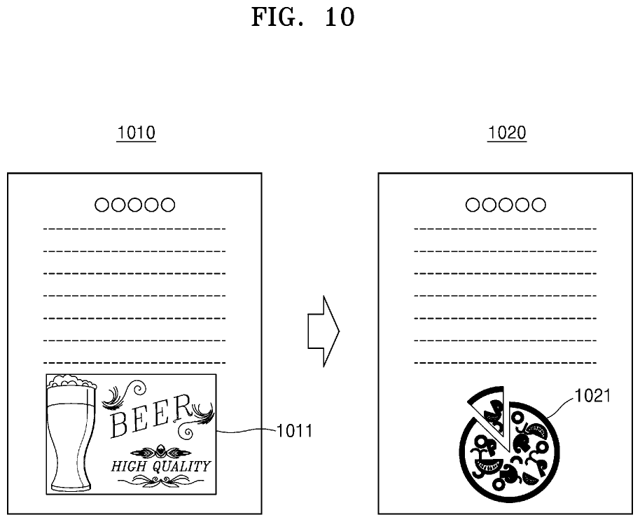

FIG. 10 is a diagram for describing a process of outputting a second printout with harmful information deleted when a first printout including the harmful information is output, according to an example of the present disclosure.

Before combining a temporary image and data corresponding to the temporary image, the image forming apparatus 10 may check whether the temporary image includes predefined harmful information. When the temporary image includes the predefined harmful information, the image forming apparatus 10 may generate a modified temporary image by deleting the harmful information from the temporary image or changing the harmful information to certain information. The image forming apparatus 10 may output an image resulting from combining the modified temporary image with data corresponding to the modified temporary image.

Referring to 1010 in FIG. 10, the image forming apparatus 10 may obtain a first temporary image. In the case of providing printouts of the first temporary image for underage students, the image forming apparatus 10 may identify harmful information that is not supposed to be included in the first temporary image. For example, the harmful information may be related to alcohol, cigarettes, or the like. Beer advertisement information 1011 may be included in the first temporary image.

Referring to 1020 in FIG. 10, the image forming apparatus 10 may identify the beer advertisement information 1011 as harmful information and change the beer advertisement information 1011 to pizza advertisement information 1021. The image forming apparatus 10 may generate a second temporary image resulting from changing the beer advertisement information 1011 to the pizza advertisement information 1021. The image forming apparatus 10 may obtain first modified data based on a modification detail about the change from the beer advertisement information 1011 to the pizza advertisement information 1021 and may obtain second data, which reflects the modification detail, by combining first data corresponding to the first temporary image with the first modified data. The image forming apparatus 10 may output an image, which results from combining the second temporary image with the second data, as a second printout. The second printout may be provided for underage students.

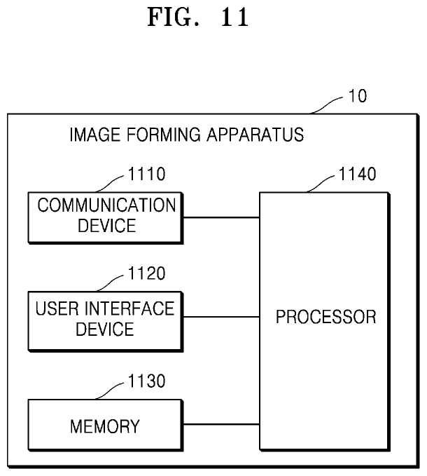

FIG. 11 is a block diagram illustrating the configuration of an image forming apparatus, according to an example of the present disclosure.

Referring to FIG. 11, the image forming apparatus 10 may include a communication device 1110, a user interface device 1120, a memory 1130, and a processor 1140. However, these elements are not necessarily essential. The image forming apparatus 10 may be implemented with more or fewer elements than those shown in FIG. 11. Hereinafter, these elements will be described.

The communication device 1110 may communicate with external devices. In detail, the communication device 1110 may communicate with external devices via wired or wireless connection to a network. Here, the external devices may include an external server managing the image forming apparatus 10 and an electronic device requesting the image forming apparatus 10 to perform a certain operation. The communication device 1110 may include a communication module supporting one of various wired/wireless communication methods. For example, the communication module may include a short-range communication module or a wired communication module.

The user interface device 1120 may include an input unit, which receives an input for controlling the operation of the image forming apparatus 10 from a user, and an output unit, which displays a result of the operation of the image forming apparatus 10 or information such as a state of the image forming apparatus 10. For example, the user interface device 1120 may include an operation panel receiving a user input and a display panel displaying a screen.

Specifically, the input unit may include, for example, devices, such as a keyboard, a physical button, a touch screen, a camera, and a microphone, which receive various types of user inputs. The output unit may include, for example, a display panel or a speaker. However, examples are not limited thereto, and the user interface device 1120 may include various devices that support input/output.

The memory 1130 may store software or programs. The memory 1130 may store at least one program related to the operation of the image forming apparatus 10 that outputs, as a printout, a result of combining an image with data in a predefined format, which is used to form the image.

The processor 1140 may execute the program stored in the memory 1130, read data or a file from the memory 1130, or store a new file in the memory 1130. The processor 1140 may execute instructions stored in the memory 1130.

The processor 1140 may obtain first data in a predefined format, which is used to form a certain image.

For example, the first data may be composed of digital code. For example, the first data may be machine language readable by the processor 1140 of the image forming apparatus 10. The first data may be used for conversion into a certain image including at least one piece of text or at least one picture.

For example, the processor 1140 may receive a print request for a certain file from an external device through the communication device 1110 or receive a copy request for a certain document from the user interface device 1120. In this case, the processor 1140 may obtain the first data in the predefined format, which is used to form a certain image, from the certain file or document.

The processor 1140 may convert the first data into a first temporary image representing first information corresponding to the first data.

For example, the image forming apparatus 10 may read the first data and obtain the first information corresponding to the first data. The first information may be represented by at least one piece of text or at least one picture. The processor 1140 may generate the first temporary image including the first information. For example, when the first data is original data of the certain document, file, or image, the first temporary image may be an original image.

The processor 1140 may check whether a modification has been performed on the first temporary image. At this time, the modification may include a modification of the entire area of the first temporary image or a modification of a partial area of the first temporary image.

When the modification has not been performed on the first temporary image, the processor 1140 may output a first image, which results from combining the first temporary image with the first data, as a first printout. For example, the processor 1140 may obtain the first image having the first data superposed on the first temporary image and output the first image as the first printout.

For example, the first data may be transparently displayed on the first printout. The first data may be displayed in a certain size in a certain area of the first printout. The first data may be displayed in a margin of the first printout. The first data displayed on the first printout may be hard to be visually identified by a user.

When the modification has been performed on the first temporary image, the processor 1140 may output a second image, which results from combing a second temporary image resulting from modification of the first temporary image with second data corresponding to a history of the modification of the first temporary image, as a second printout.

The user interface device 1120 may display the first temporary image. At this time, the first temporary image may be generated from the first data.

The user interface device 1120 may receive the first input for modifying an entire or a partial area of the first temporary image

For example, the first input may be for modifying at least one selected from words in text and the size and color of the text in a certain area of the first temporary image. The first input may be for modifying the size or color of a picture in a certain area of the first temporary image or for entirely or partially changing the picture.

In another example, the first input may request to delete a portion of the first temporary image other than a predefined format in a certain area.

In another example, the first input may request to recover the first temporary image or a certain temporary image corresponding to a state before generation of the first temporary image. For example, the first input may request to recover an original image.

The processor 1140 may obtain the second temporary image, which results from modification of the first temporary image, based on first modified data in a predefined format, wherein the first modified data is obtained from the first input.

For example, the processor 1140 may obtain the first modified data in the predefined format from the first input. When the first input is for modifying a letter in a certain area, the image forming apparatus 10 may obtain a modified letter as the first modified data in the predefined format. In detail, the processor 1140 may obtain digital code, by which the modified letter is expressed in machine language readable by a processor, as the first modified data.

For example, the processor 1140 may obtain second data by combining the first data with the first modified data. The second data may reflect a modification corresponding to the first input. For example, the processor 1140 may combine the first data with the first modified data based on a position corresponding to the first modified data in the first data and the place of the first modified data in a modification order.

The processor 1140 may convert the second data into the second temporary image, which results from modification of the entire or partial area of the first temporary image.

The history of modification of the first temporary image may include at least one of a history of modification from the first temporary image to the second temporary image and a history of modification from the original image of the first temporary image to the first temporary image.

In the same manner as the first data is displayed on the first printout, the second data may be transparently displayed on the second printout. The second data may be displayed in a certain size in a certain area of the second printout. The second data may be displayed in a margin of the second printout.

The processor 1140 may obtain a first image, which results from scanning the first printout. For example, a scanner of the image forming apparatus 10 may scan the first printout and obtain the first image as the scan result.

The processor 1140 may obtain a first temporary image, which results from extracting first data in a predefined format from the first image. For example, the processor 1140 may extract the first data in a predefined format from the first image. The processor 1140 may read the first data and convert the first data into the first temporary image including first information.

The processor 1140 may obtain a second temporary image, which results from modification of the first temporary image, based on a first input for modifying an entire or a partial area of the first temporary image.

The processor 1140 may output, as the second printout, a second image, which is generated by combining the second temporary image with second data corresponding to a modification history of the first temporary image

The method of operating the image forming apparatus 10 may be embodied as computer-readable storage media that store data or commands executable by a computer or a processor. The method can be written as computer programs and can be implemented in general-use digital computers that execute the programs using a computer-readable storage medium. The computer-readable storage media may be read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tape, floppy disks, magneto-optical data storage devices, optical data storage devices, hard disks, solid state disks (SSDs), or any devices that can store a command or software, relevant data, a data file, and a data structure and can provide the command or software, the relevant data, the data file, and the data structure to a processor or a computer to allow the processor or computer to execute the command.

While examples have been described with reference to particular examples and drawings, various changes and modifications may be made in the above descriptions by those of ordinary skill in the art. For example, even when the techniques described above are performed in a different order than described above, and/or the components such as systems, structure, devices, circuits, etc. described above are coupled to or combined with each other in different manners than described above or substituted or replaced with other components or equivalents, proper results may be obtained.

It should be understood that examples described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made therein without departing from the spirit and scope as defined by the following claims.

What is claimed is:

1. A method of operating an image forming apparatus, the method comprising:
obtaining first data in a defined format, the first data convertible to form an image;
converting the first data into the image as a first temporary image representing first information; and
outputting a first image printable as a first printout, the first image resulting from combining the first temporary image with the first data.

2. The method of claim 1, wherein the outputting of the first image includes outputting a second image printable as a second printout, when a modification is performed on the first temporary image,
the second image resulting from combining a second temporary image, which results from the modification of the first temporary image, with second data representing second information corresponding to the modification of the first temporary image, the second data convertible into the second temporary image including the modification.

3. The method of claim 1, further comprising:
obtaining the first image resulting from scanning the first printout of the first image;
obtaining the first temporary image resulting from extracting the first data in the defined format from the first image;
obtaining a second temporary image based on an input for a modification of an entire or a partial area of the first temporary image, the second temporary image resulting from modification of the first temporary image; and
outputting a second image printable as a second printout, the second image resulting from combining the second temporary image with second data representing the extracted first data and second information corresponding to the modification of the first temporary image, the second data convertible into the second temporary image including the modification.

4. The method of claim 2, wherein the outputting the second image printable as the second printout includes:
displaying the first temporary image;
receiving an input for the modification of an entire or a partial area of the first temporary image; and
obtaining the second temporary image resulting from the modification of the first temporary image based on modified data in a defined format, the modified data being obtained from the input.

5. The method of claim 4, wherein the receiving of the input for the modification of the entire or partial area of the first temporary image includes receiving at least any one of inputs selected from,
an input for modifying at least one word selected from words in text, and/or a size and color of a text in a certain area of the first temporary image,
an input for modifying a size or color of a picture in a certain area, or for entirely or partially changing the picture,
an input to delete a portion of the first temporary image other than a defined format in a certain area, or
an input requesting to recover another image corresponding to a state of outputting the first image before a generation of the first temporary image.

6. The method of claim 4, wherein the obtaining of the second temporary image based on the modified data includes:
obtaining the modified data in the defined format from the input;
obtaining the second data by combining the extracted first data with the modified data, the second data reflecting a the modification corresponding to the input; and
converting the second data into the second temporary image resulting from modifying the entire or partial area of the first temporary image.

7. The method of claim 6, wherein the obtaining of the second data by combining the first data with the modified data includes obtaining the second data by combining the first data with the modified data based on a position corresponding to the modified data in the first data and a place of the modified data in a modification order.

8. The method of claim 2, wherein the second information indicates a history of modifications of the first temporary image including at least any one of a history of modifications from the first temporary image to the second temporary image, or a history of modifications from an original image of the first temporary image to the first temporary image,
wherein the method further comprises:
obtaining the second image resulting from scanning the second printout;
obtaining a previous image at a certain time point based on the modification history of the first temporary image, the modification history being included in the second image; and
outputting a printout corresponding to the previous image.

9. The method of claim 2, wherein the outputting of the second image printable as the second printout includes:
generating the second image by combining the second temporary image with the second data, the second image having the second data superposed on the second temporary image; and
outputting the second image as the second printout.

10. The method of claim 3, wherein the obtaining of the second temporary image based on the input includes:
receiving the input for the modification of at least one item related to text or a picture in the entire or partial area of the first temporary image; and
obtaining the second temporary image resulting from modifying the at least one item in the entire or partial area of the first temporary image.

11. The method of claim 1, further comprising, when the first temporary image includes a defined harmful information:
obtaining a third temporary image by performing a modification of deleting the defined harmful information from the first temporary image or changing the defined harmful information to a certain other information; and
outputting a third image printable as a third printout, the third image resulting from combining the third temporary image with third data corresponding to the modification of the first temporary image.

12. A computer-readable storage medium storing instructions executable by a processor, the computer-readable storage medium comprising:
instructions to obtain first data in a defined format, the first data convertible to form an image;
instructions to convert the first data into the image as a first temporary image representing first information; and
instructions to output a first image printable as a first printout, the first image resulting from combining the first temporary image with the first data, or to output a second image printable as a second printout when a modification is performed on the first temporary image,
the second image resulting from combining a second temporary image, which results from the modification of the first temporary image, with second data representing second information corresponding to the modification of the first temporary image, the second data convertible into the second temporary image including the modification.

13. An image forming apparatus comprising:
a communication device;
a user interface device;
a processor; and
a memory storing instructions executable by the processor,
wherein, by executing the instructions, the processor
obtains first data in a defined format, the first data convertible to form an image,
converts the first data into the image as a first temporary image representing first information, and
outputs a first image printable as a first printout, the first image resulting from combining the first temporary image with the first data, or outputs a second image printable as a second printout when a modification is performed on the first temporary image, the second image being resulting from combining a second temporary image, which results from the modification of the first temporary image, with second data representing second information corresponding to the modification of the first temporary image, the second data convertible into the second temporary image including the modification.

14. The image forming apparatus of claim 13, wherein, by executing the instructions, the processor,
displays the first temporary image through the user interface device,
receives an input for performing a modification of an entire or a partial area of the first temporary image through the user interface device, and
obtains the second temporary image based on modified data in defined format, the modified data being obtained from the input, and the second temporary image resulting from the modification of the first temporary image.

15. The image forming apparatus of claim 13, wherein, by executing the instructions, the processor,
obtains the second image resulting from scanning the second printout,
obtains a previous image at a certain time point based on the second information indicating a modification history of the first temporary image, and
outputs a printout corresponding to the previous image.
